(19) United States
(12) Patent Application Publication
(10) Pub. No.: US 2008/0031205 A1
(43) Pub. Date: Feb. 7, 2008

(54) Scalable WLAN wireless communications device and radio for WPAN and WRAN operation

(76) Inventors: Mika Kahola, Masala (FI); Mika Kasslin, Espoo (FI); Timo Lunttila, Espoo (FI)

Correspondence Address: MORGAN & FINNEGAN, LLP, 3 World Financial Center, New York, NY, 10281-2101, US

(21) Appl. No.: 11/497,253

(22) Filed: Aug. 2, 2006

(51) Int. Cl. H04Q 7/24

(52) U.S. Cl. 370/338

(57) ABSTRACT

An apparatus and method for wireless devices have a scalable bandwidth allocation for operating in different bands at different data rates and provide interference prevention between co-existing modes of operation. MAC frame logic selectively defines first characteristics of a first operational mode corresponding to a first wireless link type and second characteristics of a second operational mode corresponding to a second wireless link type. A transceiver coupled to the MAC frame logic communicates, in response to the MAC frame specification, a first protocol data unit for the first operational mode having the first characteristics for the first wireless link type and a second protocol data unit for the second operational mode having the second characteristics for the second wireless link type. Interference detecting logic detects interference conditions in the first wireless link type and allocates suitable areas for operation of the second wireless link. The same principle used in scaling WLAN to WPAN operation, can also be applied at the lower bit rate of WRAN, in which case a larger range is achieved using a narrower bandwidth and lower a clock rate.

### FIELD OF THE INVENTION

The present invention relates to wireless communications. More particularly, the present invention relates to wireless devices having a scalable bandwidth allocation for operating at different data rates and providing interference prevention between co-existing modes of operation.

### BACKGROUND OF THE INVENTION

The problem in the prior art is how to reduce the number of separate radios for a multiradio device to minimize the size, weight, cost, interference and complexity of control when a wireless device is meant to accommodate more and more wireless bands.

Wireless access communications technologies, such as Bluetooth, wireless local area networks (WLAN), ultra wideband (UWB), and sensor radios (e.g. ZigBee) are becoming increasingly available and important for portable devices. Such technologies often complement more traditional cellular access technologies to provide a portable device with expanded communications capabilities.

Each individual access technology is often well-suited for particular types of uses and applications. Thus, for a device to provide its user with the ability to experience a multitude of applications (e.g. wireless headset, fast internet access, synchronization, and content downloading), it is desirable for a device to support multiple access technologies.

WLANs are local area networks that employ high-frequency radio waves rather than wires to exchange information between devices. IEEE 802.11 refers to a family of WLAN standards developed by the IEEE. In general, WLANs in the IEEE 802.11 family provide for 1 or 2 Mbps transmission in the 2.4 GHz band (except IEEE 802.11a) using either frequency hopping spread spectrum (FHSS) or direct sequence spread spectrum (DSSS) transmission techniques. Within the IEEE 802.11 family are the IEEE 802.11b, IEEE 802.11g, and IEEE 802.11a standards.

IEEE 802.11b (also referred to as 802.11 High Rate or Wi-Fi) is an extension to IEEE 802.11 and provides data rates of up to 11 Mbps in the 2.4 GHz band. This allows for wireless functionality that is comparable to Ethernet. IEEE 802.11b employs only DSSS transmission techniques. IEEE 802.11g provides for data rates of up to 54 Mbps in the 2.4 GHz band. For transmitting data at rates above 20 Mbps (or when all devices are IEEE 802.11g capable), IEEE 802.11g employs Orthogonal Frequency Division Multiplexing (OFDM) transmission techniques. However, for transmitting information at rates below 20 Mbps, IEEE 802.11g employs DSSS transmission techniques. The DSSS transmission techniques of IEEE 802.11b and IEEE 802.11g involve signals that are contained within a 20 MHz wide channel. These 20 MHz channels are within the Industrial Scientific Medical (ISM) band. IEEE 802.11a employs OFDM transmission techniques and provides for data rates of up to 54 Mbps in a 5 GHz band.

The IEEE 802.11 Wireless LAN Standard defines one common medium access control (MAC) specification for the IEEE 802.11b, IEEE 802.11g, and IEEE 802.11a standards. Each wireless station and access point in an IEEE 802.11 wireless LAN implements the MAC layer service, which provides the capability for wireless stations to exchange MAC frames. The MAC frame transmits management, control, or data between wireless stations and access points. After a station forms the applicable MAC frame, the frame's bits are passed to the Physical Layer (PHY) for transmission.

The MAC layer accepts MAC Service Data Units (MSDUs) from higher layers and adds headers and trailers to create MAC Protocol Data Units (MPDUs) or frames. IEEE 802.11 includes extensive management capabilities defined at the MAC level in management frames. All management frames include: Frame Control, Duration, Address, Sequence Control, Frame Body, Element ID, Length, Information (variable length), and Frame Check Sequence (FCS) fields. Components of the Management Frame Body include Supported Rates field of 1-8 bytes. Each byte represents a single rate where the lower 7 bits of the byte represents the rate value and the most significant bit indicates whether the rate is mandatory or not. The Supported Rates field is transmitted in the Beacon, probe response, association request, association response, re-association request, and re-association response frames.

The Physical Layer (PHY) Functionality is the interface between the MAC layer and wireless media, which transmits and receives management, control and data frames over the shared wireless media. The PHY layer provides three levels of functionality: First, the PHY layer provides a frame exchange between the MAC layer and PHY layer under the control of the physical layer convergence procedure (PLCP) sublayer. Secondly, the PHY layer uses various modulation techniques to transmit data frames over the media under the control of the physical medium dependent (PMD) sublayer. Thirdly, the PHY layer provides a carrier sense indication back to the MAC to verify activity on the media.

The Direct Sequence Spread Spectrum (DSSS) PHY uses the 2.4 GHz frequency band as the RF transmission medium. Data transmission over the medium is controlled by the DSSS PMD sublayer as directed by the DSSS PLCP sublayer. The DSSS PMD takes the binary bits of information from the PLCP protocol data unit (PPDU) and transforms them into RF signals for the wireless media by using carrier modulation and DSSS techniques.

The PLCP protocol data unit (PPDU) is unique to the DSSS PHY layer. The PPDU frame consists of a PLCP preamble, PLCP header, and MAC protocol data unit (MPDU). The PLCP signal field defines which type of modulation is used in the incoming MPDU.

The IEEE 802.11a PHY orthogonal frequency division multiplexing (OFDM) PHY provides the capability to transmit PHY Service Data Unit (PSDU) frames at multiple data rates up to 54 Mbps for WLAN networks where transmission of multimedia content is a consideration. The PPDU is unique to the OFDM PHY layer. The PPDU frame consists of a PLCP preamble and signal and data fields. The receiver uses the PLCP preamble to acquire the incoming OFDM signal and synchronize the demodulator. The PLCP header contains information about the PHY Service Data Unit (PSDU) from the sending node's OFDM PHY layer. The PLCP preamble field is used to acquire the incoming signal to train and synchronize the receiver.

The SIGNAL field is a 24-bit field, which contains information about the rate and length of the PSDU. As shown in FIG. 2B for the WLAN SIGNAL field, four bits (R1-R4) are used to encode the rate, twelve bits are defined for the length, one reserved bit, a parity bit, and six “0” tail bits. The length field is an unsigned 12-bit integer that indicates the number of octets in the PSDU. The data field contains the service field, PSDU, tails bits, and pad bits.

In contrast, Wireless personal area networks (WPANs) have a shorter range than do WLANs. WPANs are used for exchanging information with devices, such as portable telephones and personal digital assistants (PDAs), which are within close proximity. Examples of WPAN technologies include Infrared Data Association (IrDA) and Bluetooth.

Bluetooth defines a short-range radio network (also referred to as a piconet). It can be used to create ad hoc networks of up to eight devices, where one device is referred to as a master device and the other devices are referred to as slave devices. The slave devices can communicate with the master device and with each other via the master device. Bluetooth devices are designed to find other Bluetooth devices within their communications range and to discover what services they offer. A typical range for a Bluetooth piconet is 10 meters. However, in certain circumstances, ranges on the order of 100 meters may be attained.

ZigBee is a wireless communications access technology that, like Bluetooth and IEEE 802.11b, operates in the 2.4 GHz (ISM) radio band. Zigbee can connect up to 255 devices per network and provide for data transmission rates of up to 250 Kbps at a range of up to 30 meters. While slower than IEEE 802.11b and Bluetooth, ZigBee devices consume less power.

High rate WPAN schemes are currently under development that employ wireless technologies, such as ultra wideband (UWB) transmission, which provides for the exchange of information at higher data rates. Since gaining approval by the Federal Communications Commission (FCC) in 2002, UWB techniques have become an attractive solution for short-range wireless communications. Current FCC regulations permit UWB transmissions for communications purposes in the frequency band between 3.1 and 10.6 GHz. However, for such transmissions, the average spectral density has to be under −41.3 dBm/MHz and the utilized −10 dBc bandwidth has to be higher than 500 MHz.

There are many UWB transmission techniques that can fulfill these requirements. A common and practical UWB technique is called impulse radio (IR). In IR, data is transmitted by employing short baseband pulses that are separated in time by gaps. Thus, IR does not use a carrier signal. These gaps make IR much more immune to multipath propagation problems than conventional continuous wave radios. RF gating is a particular type of IR in which the impulse is a gated RF pulse. This gated pulse is a sine wave masked in the time domain with a certain pulse shape.

One example of a Wireless Regional Area Network (WRAN) system is a new standard now in development, to be specified as the IEEE 802.22 standard. 802.22 WRAN is to be an interoperable air interface for use in spectrum allocated to TV Broadcast Service. It is to provide packet-based transport that supports internet access, data transport, voice and streaming video. 802.22 WRAN is to enable a wireless broadband access for geographically dispersed, sparsely populated areas, with a transmission up to 100 Km. The standard is to specify the air interface, including the medium access control layer (MAC) and physical layer (PHY), of fixed point-to-multipoint wireless regional area networks operating in the VHF/UHF TV broadcast bands between 54 MHz and 862 MHz.

As discussed above, it is desirable for a device to support multiple access technologies. One approach to this is furnishing the device with multiple radios—one for each access technology. However, this approach brings several drawbacks. For instance, every additional radio brings forth an added cost as well as the need for additional physical space on a circuit board (and potentially a dedicated antenna). Moreover, controlling several radios adds complexity to device control. In addition, each separate radio creates a distinct reliability issue. With regard to the development of new devices, the needed effort to design and provide new radios for certain types of links causes delays and additional project risks.

Accordingly, there is a need to support multiple access technologies without furnishing devices with additional radios.

### SUMMARY OF THE INVENTION

An aspect of the invention is a single radio to provide scalable bandwidth allocation for operating at different data rates and provide interference prevention between co-existing modes of operation. MAC frame logic selectively defines first characteristics of a first operational mode of the radio corresponding to a first wireless link type, such as WLAN and second characteristics of a second operational mode of the radio corresponding to a second wireless link type, such as WPAN. A radio transceiver coupled to the MAC frame logic communicates, in response to the MAC frame specification, a first protocol data unit for the first operational mode having the first characteristics for the WLAN link and a second protocol data unit for the second operational mode having the second characteristics for the WPAN link. Interference detecting logic detects interference conditions in the WLAN link and allocates suitable areas for operation of the WPAN link. The MAC frame logic may set the operational mode of the transceiver according to an event, such as the receipt of a message or may set the operational mode based on an application.

The same principle used in scaling WLAN to WPAN operation, can also be applied at the lower bit rate of WRAN, in which case a larger range is achieved using a narrower bandwidth and lower a clock rate.

Further features and advantages will become apparent from the following description and accompanying drawings.

### BRIEF DESCRIPTION OF THE DRAWINGS

In the drawings, like reference numbers generally indicate identical, functionally similar, and/or structurally similar elements.

FIG. 1 is a network diagram showing an example application of a scalable WLAN telephone with a single radio communicating over both a WLAN link to a WLAN access point and a WPAN link to a Media Center or Personal Computer, according to one aspect of the invention. In the example shown in FIG. 1, the scalable WLAN telephone is operating in the WLAN mode to access video files from the Internet through a WLAN access point.

FIG. 1′ shows the scalable WLAN telephone of FIG. 1 when operating in the WPAN mode to download video files to a media center or PC.

FIG. 1A is a functional block diagram of the general architecture of a scalable WLAN device according to an aspect of the invention, to provide scalable bandwidth allocation for operating at different data rates and provide interference prevention between co-existing modes of operation.

FIG. 1B is a more detailed functional block diagram of the scalable WLAN device according to an aspect of the invention.

FIG. 2A is a functional block diagram of the MAC frame logic that selectively defines first characteristics of a first operational mode of the radio corresponding to a first wireless link type, such as WLAN and second characteristics of a second operational mode of the radio corresponding to a second wireless link type, such as WPAN, according to an aspect of the invention.

FIG. 2B is a format diagram of the SIGNAL field of a PPDU frame defined by the MAC frame logic for a WLAN link, according to an aspect of the invention.

FIG. 2C is a format diagram of the SIGNAL field of a PPDU frame defined by the MAC frame logic for a WPAN link, according to an aspect of the invention.

FIG. 3A is another view of the format diagram of the SIGNAL field of a PPDU frame defined by the MAC frame logic for a WPAN link.

FIG. 3B is a table showing the contents of the data rate field in the SIGNAL field of FIG. 3A, according to an aspect of the invention.

FIG. 3C is a table showing the contents of the interference field in the SIGNAL field of FIG. 3A, according to an aspect of the invention.

FIG. 4A is a flow diagram of a WLAN/WPAN interference avoidance program in the WLAN mode, according to an aspect of the invention.

FIG. 4B is a flow diagram of a WLAN/WPAN interference avoidance program in the WPAN mode, according to an aspect of the invention.

FIG. 4C is a flow diagram of a WLAN/WRAN interference avoidance program in the WRAN mode, according to an aspect of the invention.

FIG. 5 is a functional block diagram of an adaptable receiver portion of a radio, according to an aspect of the invention.

FIG. 6 is a functional block diagram of an adaptable transmitter portion of a radio, according to an aspect of the invention.

FIG. 7 is a radio frequency spectrum diagram illustrating an example of WLAN and WPAN band allocation at 5.2 GHz band, according to an aspect of the invention.

FIG. 8 is a radio frequency spectrum diagram illustrating a first example of WPAN co-existing with WLAN, wherein the WLAN radio measures the WLAN interference and based on that channel information the radio operating in WPAN mode omits using the OFDM subcarriers overlapping with the WLAN spectrum for transmission.

FIG. 9 is a radio frequency spectrum diagram illustrating a second example of WPAN co-existing with WLAN, wherein the WPAN radio measures the WLAN interference and based on that channel information the radio operating in WPAN mode omits using the OFDM subcarriers overlapping with the WLAN spectrum for transmission.

FIG. 10 is a bit rate vs. range diagram for Scaling WLAN to WRAN, illustrating that the same principle used in scaling WLAN to WPAN operation, can also be at the lower bit rate of WRAN, in which case a larger range is achieved using a narrower bandwidth and lower a clock rate.

### DETAILED DESCRIPTION OF THE PREFERRED EMBODIMENTS

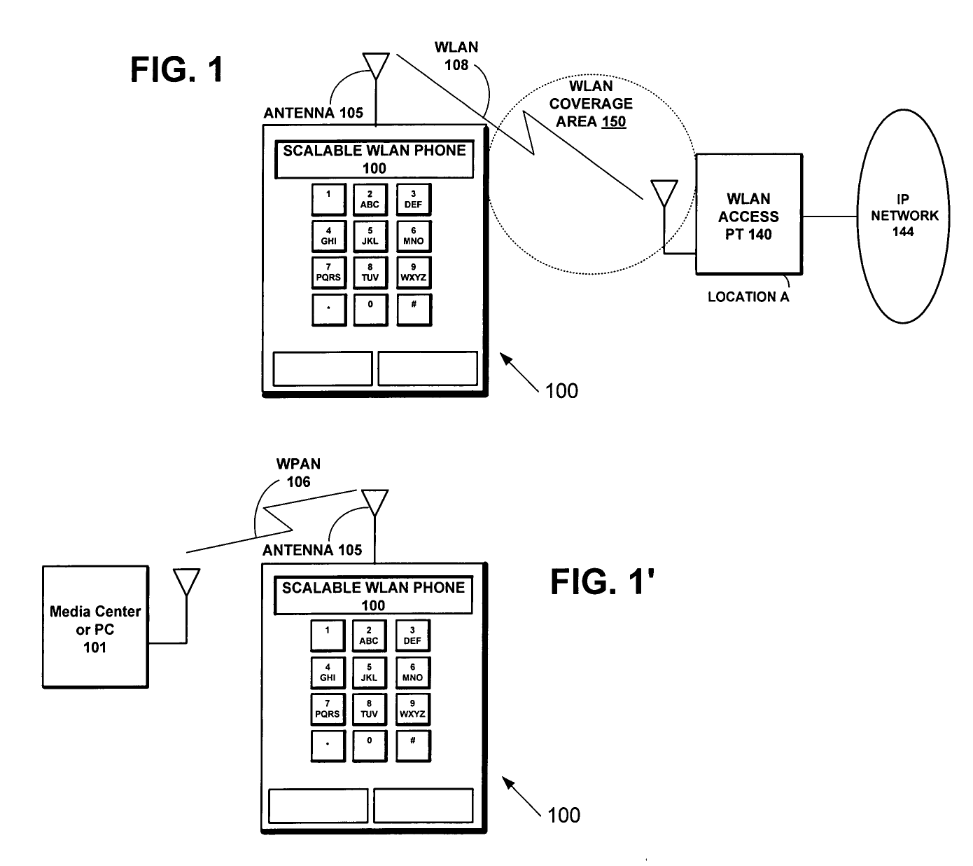

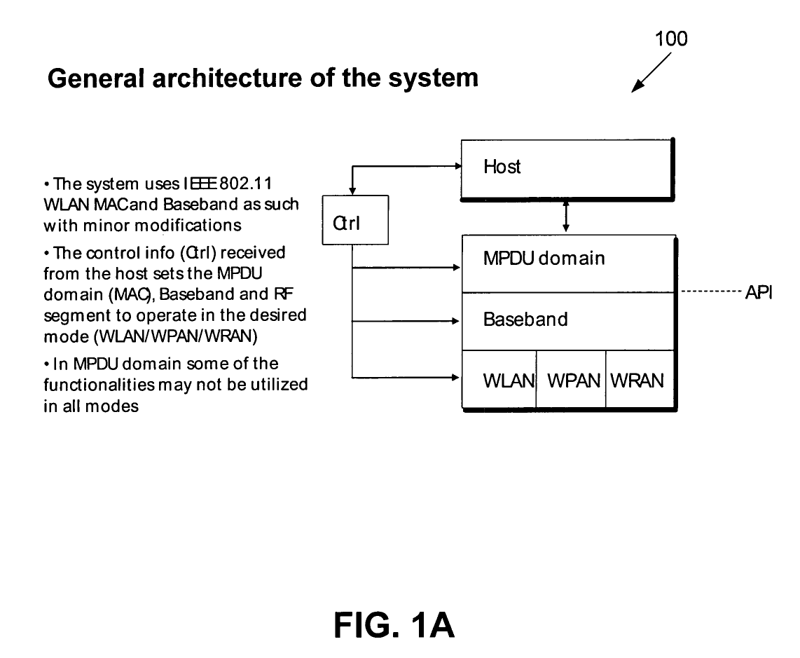

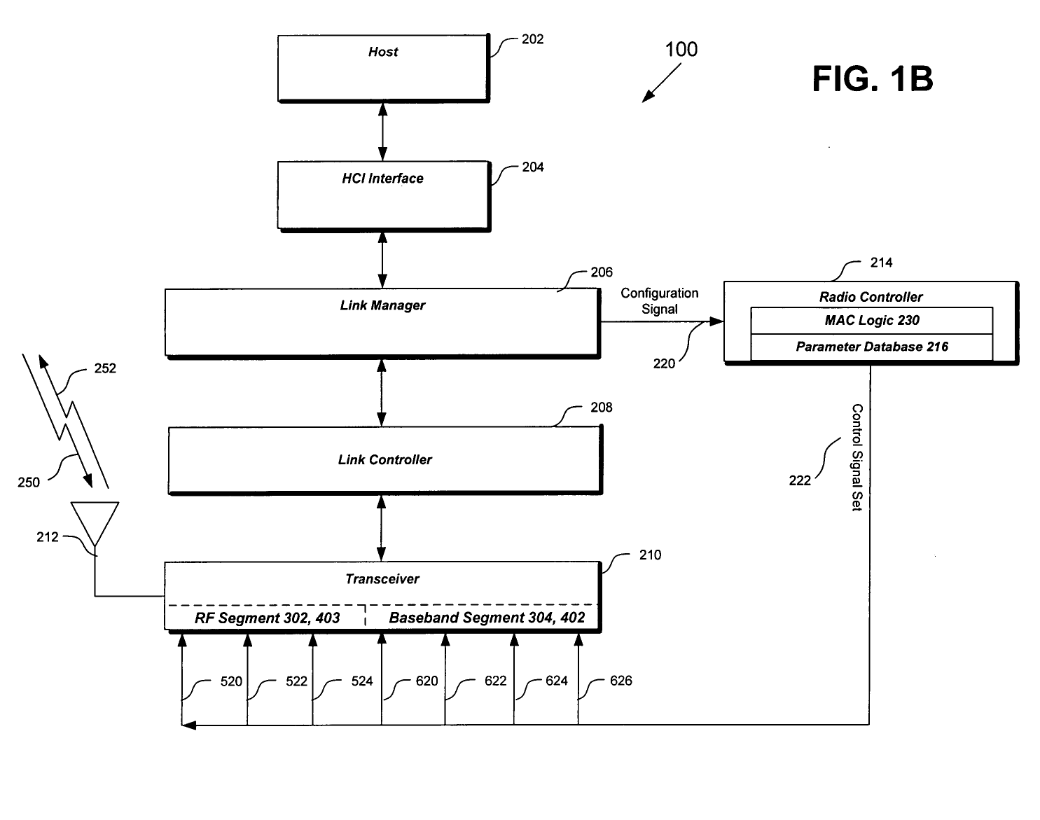

FIGS. 1 and 1′ show an example application of a scalable WLAN telephone 100 with a single radio and antenna 105 communicating over a WLAN link 108 to a WLAN access point 140 in FIG. 1 and communicating over a WPAN link 106 to a Media Center or Personal Computer 101 in FIG. 1′, according to one aspect of the invention. In the example shown in FIG. 1, the scalable WLAN telephone 100 is operating in the WLAN mode in a WLAN coverage area 150 to access video files from the Internet 144 through a WLAN access point 140. FIG. 1′ shows the scalable WLAN telephone 100 of FIG. 1, selectively scaled up to operate in the WPAN mode to download video files to a media center or PC over the WPAN link 106.

FIG. 1A is a functional block diagram of the general architecture of a scalable WLAN device 100 according to an aspect of the invention, to provide scalable bandwidth allocation for operating at different data rates and provide interference prevention between co-existing modes of operation. The existing IEEE 802.11a/g WLAN radio is also utilized for high rate WPAN usage, thereby avoiding adding another radio to the device. The IEEE 802.11 WLAN MAC and PHY baseband functionalities are used, providing a single radio for both WPAN and WRAN use, having minimal complexity, cost and real estate. The IEEE 802.11 MAC is run on top of different OFDM based PHY standards, such as IEEE 802.11a/g WLAN standard. The control information from the host sets the system to operate in a desired mode. The functionality in the MPDU domain is mainly software and can be easily configured to operate in WPAN mode. In WPAN mode only part of WLAN MPDU domain functionality needs to be used.

FIG. 1B is a more detailed functional block diagram of the scalable WLAN device 100 according to an aspect of the invention. The device architecture of FIG. 1B includes a host 202, a host controller interface (HCI) 204, a link manager 206, a link controller 208, a transceiver (or radio) 210, and an antenna 212. In addition, the architecture of FIG. 1B includes a radio controller 214. The radio controller 214 includes the MAC frame logic 230 and the parameter database 216. Device architectures, such as the architecture of FIG. 1B, may be implemented in hardware, software, firmware, or any combination thereof.

Host 202 is responsible for functions involving user applications and higher protocol layers. Therefore, host 202 may include various applications. Such an application may require information to be transmitted across different types of links. For instance, host 202 may include a browser application that requires a lower data rate link for the reception of typical content, but a higher data rate link for the reception of certain objects such as images, video content, and files.

Link manager 206 performs functions related to link set-up, security and control. These functions involve discovering corresponding link managers at remote devices and communicating with them according to the link manager protocol (LMP). More particularly, link manager 206 exchanges LMP protocol data units (PDUs) with link managers at remote devices.

Link manager 206 exchanges information with host 202 across HCI 204. This information may include commands received from host 202, and information transmitted to host 202. Examples of such commands may include directives from host 202 to employ a certain link type.

The device architecture of FIG. 1B includes a link controller 208, which operates as an intermediary between link manager 206 and transceiver 210 for each particular type of link. For example, link controller 208 may selectively operate as an intermediary for a WLAN link, as an intermediary for a higher data rate WPAN link, or as an intermediary for a lower data rate WRAN link.

The link controller 208 performs the Logical Link Control (LLC) functions of the upper sublayer of the OSI data link layer and exchanges data with the link controllers at remote devices according to physical layer protocols. Examples of such physical layer protocols include retransmission protocols such as the automatic repeat request (ARQ) protocol.

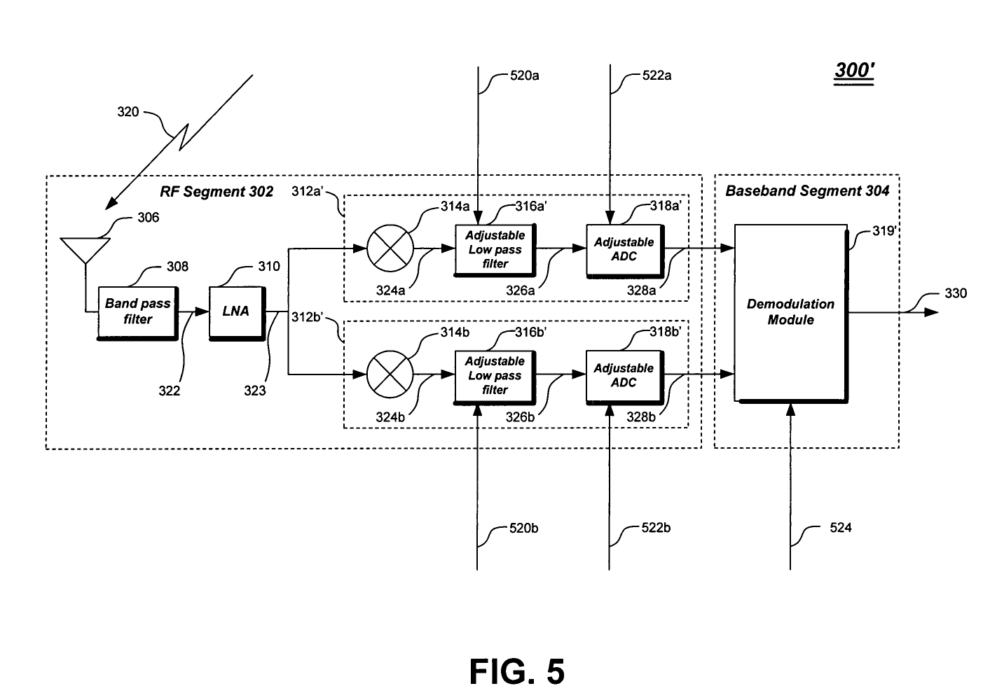

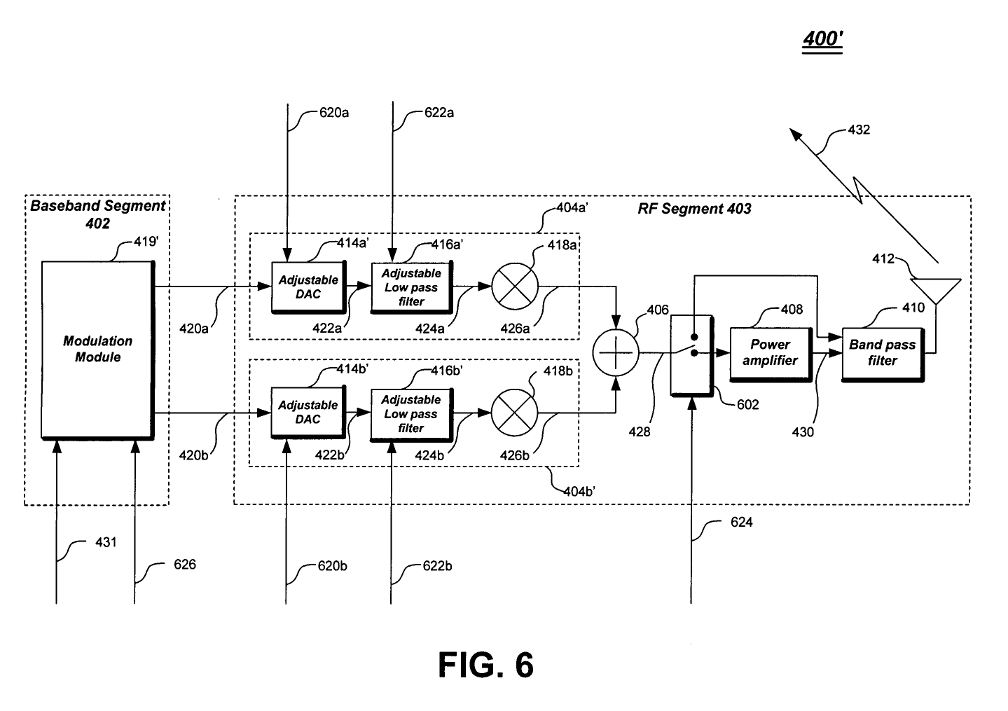

Transceiver 210 is coupled to antenna 212. Transceiver 210 includes components that allow (in conjunction with antenna 212) the exchange of wireless signals with remote devices. Such components include modulators, demodulators, amplifiers, and filters. Transceiver 210 may support various wireless link types. Therefore, transceiver may include configurable receiver and transmitter portions such as the ones of FIGS. 5 and 6.

Radio controller 214 is coupled between link manager 206 and transceiver 210. As shown In FIG. 1B, a configuration signal 220 is sent from link manager 206 to controller 214. Based on signal 220, the MAC frame logic 230 in controller 214 generates a control signal set 222. Control signal set 222 includes one or more control signals that establish operational characteristics of transceiver 210. For example, as described above with reference to FIGS. 5 and 6, control signal set 222 may include signals 520, 522, 524, 620, 622, 624, and 626.

As shown in FIG. 1B, radio controller may include a parameter database 216, which can be the IEEE 802.11 management information base (MIB). The MIB contains a number of configuration parameters that allow an external management agent to determine the status and configuration of an IEEE 802.11 station. The MAC MIB comprises two sections: the station management attributes and the MAC attributes. The station management attributes are associated with the configuration of options in the MAC and the operation of MAC management. The MAC attributes are associated with the operation of the MAC and its performance. The parameter database 216 includes multiple parameter sets for various communications or access technologies. An exemplary parameter database 216 may include parameter sets for technologies such as different WLAN standards (e.g., different standards or extensions with the IEEE 802.11 family), Bluetooth, ZigBee, and high rate WPAN technologies such as UWB.

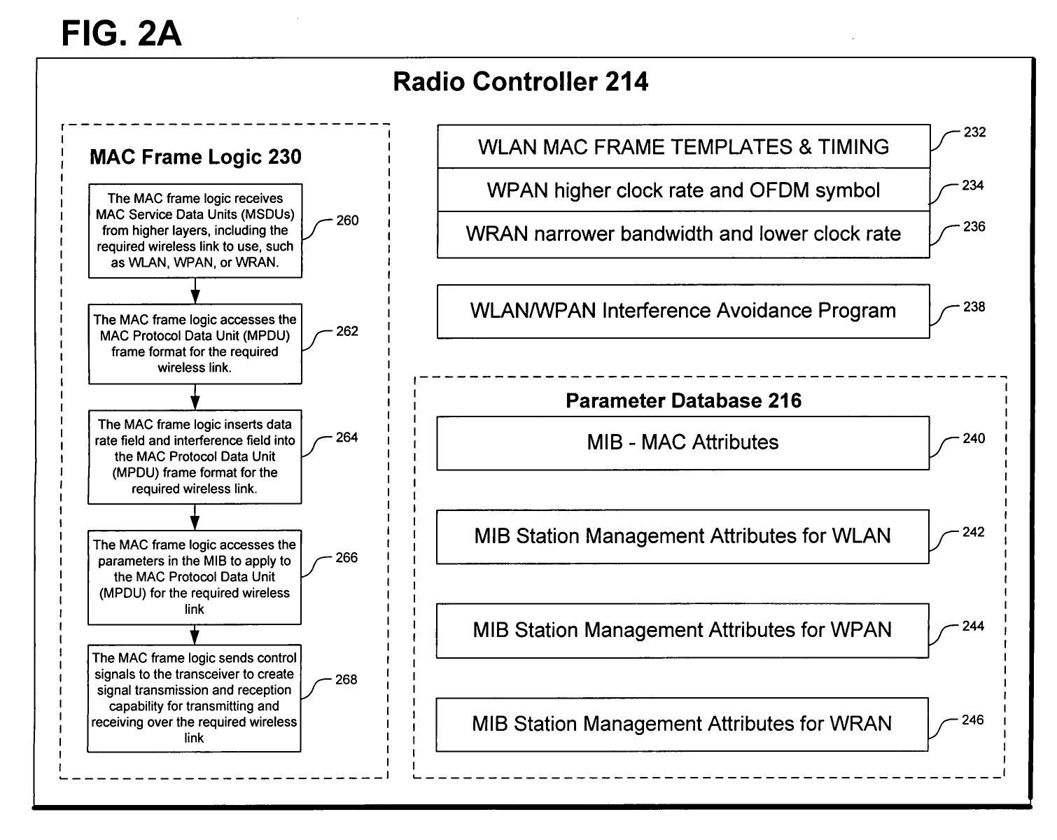

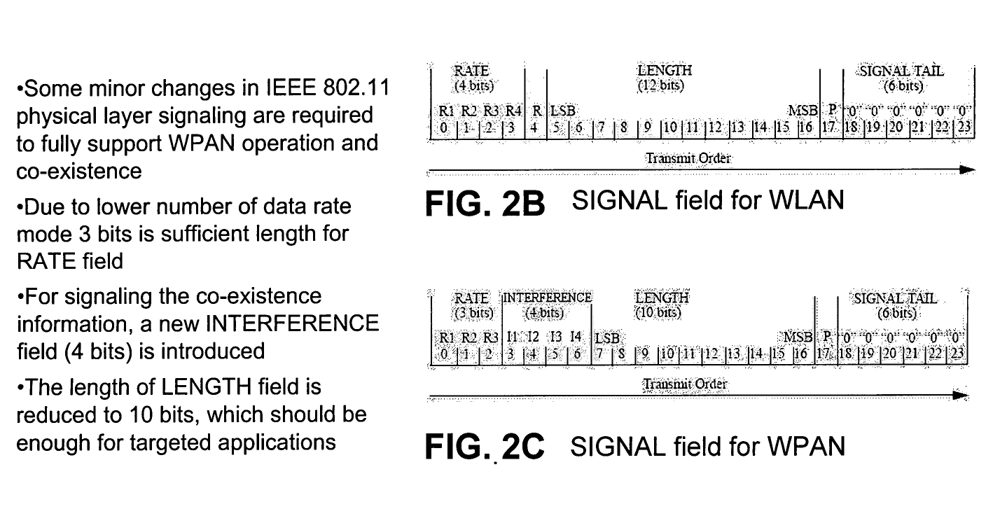

FIG. 2A is a functional block diagram of the Radio controller 214, which includes the MAC frame logic 230, the parameter database 216, WLAN MAC frame templates & timing 232, WPAN higher clock rate and OFDM symbol 234, WRAN narrower bandwidth and lower clock rate 236, and WLAN/WPAN Interference Avoidance Program 238. The MAC frame logic 230 selectively defines first characteristics of a first operational mode of the radio corresponding to a first wireless link type, such as WLAN and second characteristics of a second operational mode of the radio corresponding to a second wireless link type, such as WPAN, according to an aspect of the invention. The MAC frame logic 230 can also selectively define third characteristics of a third operational mode of the radio corresponding to a third wireless link type, such as WRAN.

The MAC frame logic 230 of FIG. 2A is depicted as a flow diagram of a sequence of steps that can be implemented in either hardware, firmware, or program software or combinations thereof. In step 260, the MAC frame logic receives MAC Service Data Units (MSDUs) from higher layers via the configuration signal 220, including the required wireless link to use, such as WLAN, WPAN, or WRAN. In step 262, the MAC frame logic accesses the MAC Protocol Data Unit (MPDU) frame format for the required wireless link, which is accessed from the WLAN MAC frame templates & timing 232, the WPAN higher clock rate and OFDM symbol 234, and/or the WRAN narrower bandwidth and lower clock rate 236, depending on whether the required wireless link is WLAN, WPAN, or WRAN, respectively. In step 264, the MAC frame logic inserts data rate field and interference field into the MAC Protocol Data Unit (MPDU) frame format for the required wireless link, depending on which wireless link is required, WLAN, WPAN, or WRAN. In step 266, the MAC frame logic accesses the parameters in the MIB to apply to the MAC Protocol Data Unit (MPDU) for the required wireless link, including the MIB-MAC Attributes 240, and either the MIB Station Management Attributes for WLAN 242, for WPAN 244, or for WRAN 246, depending on which wireless link is required, WLAN, WPAN, or WRAN. Then in step 268, the MAC frame logic sends control signals 520, 522, 524, 620, 622, 624, and 626 to the transceiver 210 to create signal transmission and reception capability for transmitting and receiving signal packets over the required wireless link.

FIG. 2B is a format diagram of the SIGNAL field of a PPDU frame defined by the MAC frame logic for a WLAN link, according to an aspect of the invention. The SIGNAL field of FIG. 2B corresponds to the IEEE 802.11 WLAN standard. The SIGNAL field is a 24-bit field, which contains information about the rate and length of the PSDU. As shown in FIG. 2B for the WLAN SIGNAL field, four bits (R1-R4) are used to encode the rate, twelve bits are defined for the length, one reserved bit, a parity bit, and six “0” tail bits. The length field is an unsigned 12-bit integer that indicates the number of octets in the PSDU. The data field contains the service field, PSDU, tails bits, and pad bits.

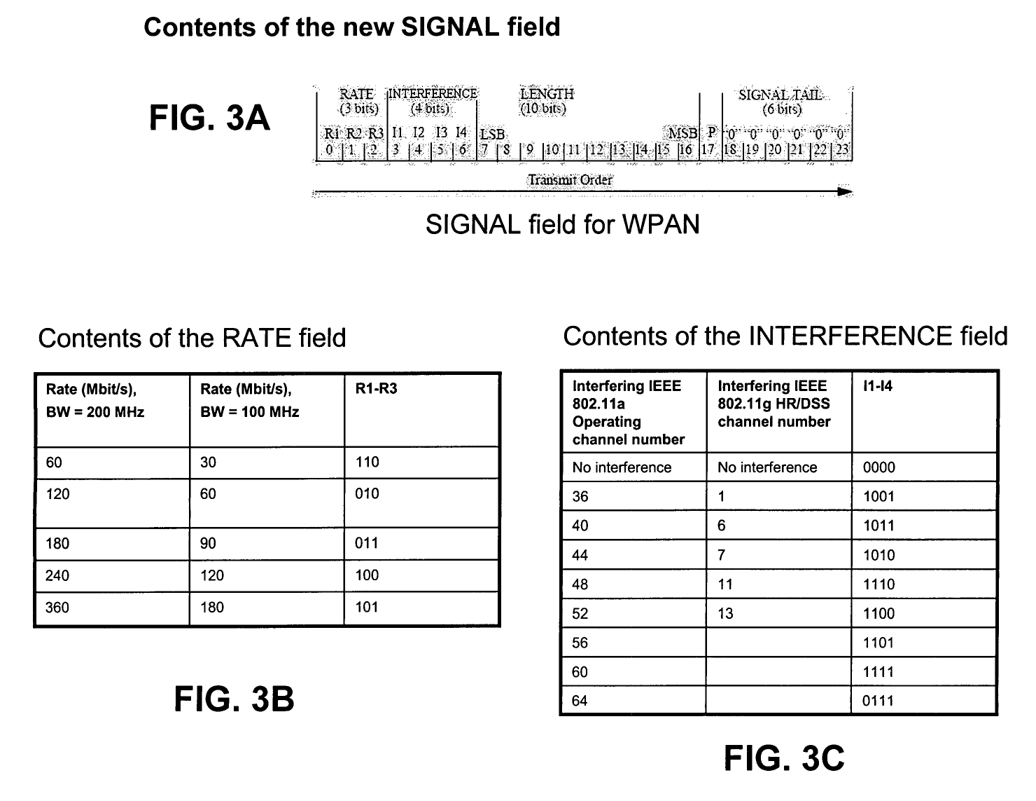

FIG. 2C is a format diagram of the SIGNAL field of a PPDU frame defined by the MAC frame logic for a WPAN link, according to an aspect of the invention. The digital baseband functionality in the WPAN mode, including PPDU frame format, remains almost the same as in WLAN. The exceptions are higher clock rate and possible changes to SIGNAL OFDM symbol defined in IEEE 802.11a. The changes to SIGNAL symbol are necessary in communicating between the WPAN transceivers if there is WLAN traffic on certain part of the spectrum so that the WPAN radios can avoid using this band and guarantee coexistence of all these radios. It is also possible to append a second SIGNAL OFDM symbol after the first one to carry the necessary information. As shown in FIG. 2C for the WPAN SIGNAL field, three bits (R1-R3) are used to encode the rate, ten bits are defined for the length, a parity bit, and six “0” tail bits. A new feature is the provision of four interference bits (I1-I4), which specify which WLAN operating channels are likely to interfere with the WPAN link. The four interference bits are specified in greater detail in FIG. 3C.

FIG. 3A is another view of the format diagram of the SIGNAL field of a PPDU frame defined by the MAC frame logic for a WPAN link. FIG. 3B is a table showing the contents of the data rate field in the SIGNAL field of FIG. 3A, according to an aspect of the invention. Data rates are specified for two different bandwidths, 100 MHz and 200 MHz. FIG. 3C is a table showing the contents of the interference field in the SIGNAL field of FIG. 3A, according to an aspect of the invention. Interfering channel numbers are specified for a WLAN operating with the IEEE 802.11a standard and for a WLAN operating with the IEEE 802.11g standard.

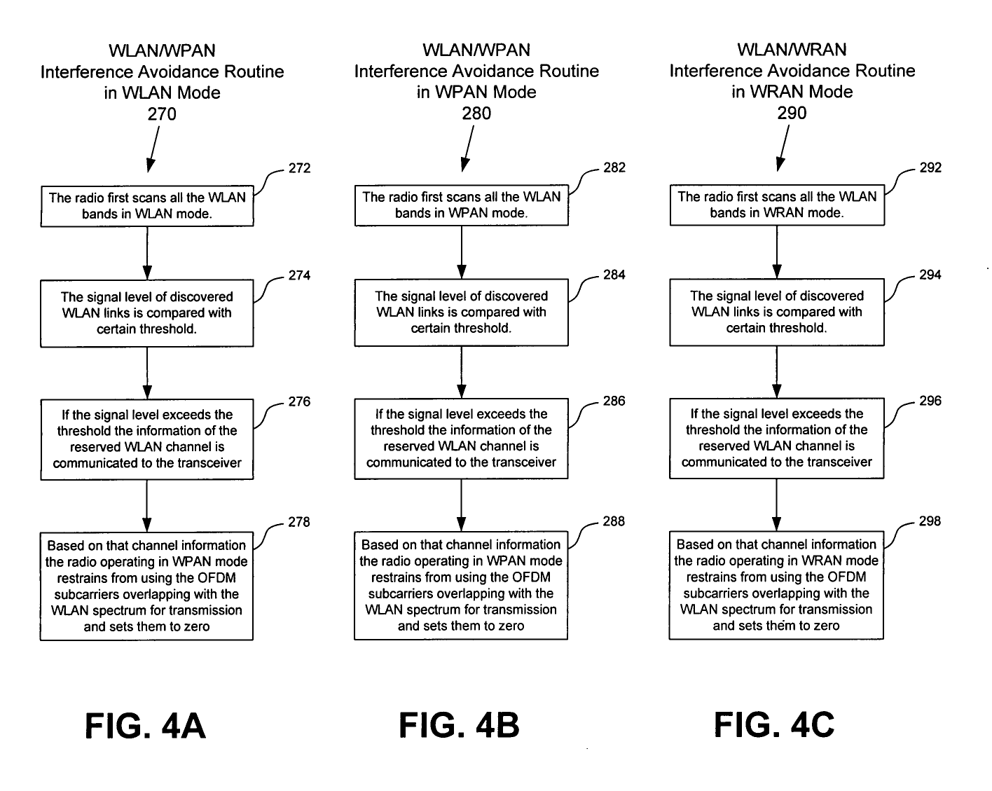

FIG. 4A is a flow diagram 270 of a WLAN/WPAN interference avoidance program 238 in the WLAN mode, according to an aspect of the invention. The sequence of steps includes step 272 wherein the radio first scans all the WLAN bands in WLAN mode. In Step 274, the signal level of discovered WLAN links is compared with certain threshold. In step 276, if the signal level exceeds the threshold, the information of the reserved WLAN channel is communicated to the transceiver. Then in step 278, based on that channel information, the radio operating in WPAN mode omits using the OFDM subcarriers overlapping with the WLAN spectrum for transmission and sets them to zero.

FIG. 4B is a flow diagram 280 of a WLAN/WPAN interference avoidance program 238 in the WPAN mode, according to an aspect of the invention. The sequence of steps includes step 282 wherein the radio first scans all the WLAN bands in WPAN mode. In Step 284, the signal level of discovered WLAN links is compared with certain threshold. In step 286, if the signal level exceeds the threshold, the information of the reserved WLAN channel is communicated to the transceiver. Then in step 288, based on that channel information, the radio operating in WPAN mode omits using the OFDM subcarriers overlapping with the WLAN spectrum for transmission and sets them to zero.

FIG. 4C is a flow diagram 290 of a WLAN/WRAN interference avoidance program 238 in the WRAN mode, according to an aspect of the invention. The sequence of steps includes step 292 wherein the radio first scans all the WLAN bands in WRAN mode. In Step 294, the signal level of discovered WLAN links is compared with certain threshold. In step 296, if the signal level exceeds the threshold, the information of the reserved WLAN channel is communicated to the transceiver. Then in step 298, based on that channel information, the radio operating in WRAN mode omits using the OFDM subcarriers overlapping with the WLAN spectrum for transmission and sets them to zero.

FIG. 5 is a functional block diagram of an adaptable receiver portion of a radio, according to an aspect of the invention. The receiver portion 300′ of the transceiver 210 includes processing paths 312a′ and 312b′. Each of these processing paths includes an adjustable low pass filter 316′ and an adjustable ADC 318′. Also, receiver portion 300′ includes a demodulation module 319′ that may be adjusted to perform demodulation operations that are suitable for the employed link. For example, the modulation type and/or coding parameters may be adjusted based on the employed link.

Adjustable low pass filters 316′ each have a bandwidth that is determined by a corresponding control signal 520. Each adjustable ADC 318′ has a sampling rate and a resolution that are determined by a corresponding control signal 522. The demodulation operations performed by demodulation module 319′ are determined by a control signal 524. Signals 520, 522, and 524 are received from the radio controller 214.

FIG. 6 is a functional block diagram of an adaptable transmitter portion of a radio, according to an aspect of the invention. The transmitter portion 400′ of the transceiver 210 includes various adjustable components. These adjustable components include processing paths 404a′ and 404b′. Each of these processing paths includes an adjustable DAC 414′ and an adjustable low pass filter 416′. In addition, transmitter portion 400′ includes an adjustable modulation module 419′.

Adjustable DACs 414′ each have a sampling rate and resolution that are determined by a corresponding control signal 620. Adjustable low pass filters 416′ each have a bandwidth that is determined by a corresponding control signal 622. In addition to these adjustable components, transmitter portion 400′ includes a switching module 602. Switching module 602 allows power amplifier 408 to be bypassed based on a control signal 624.

Modulation module 419′ maybe adjusted to perform modulation operations that are suitable for the employed link. For example, the modulation type and/or coding parameters may be adjusted based on the employed link. These operations are determined by a control signal 626. Control signals 620, 622, 624, and 626 are received from the radio controller 214. The receiver 300′ and transmitter 400′ of the transceiver 210 are described in greater detail in the copending U.S. patent application Ser. No. 10/959,105, filed Oct. 7, 2004, published on Apr. 13, 2006 as Publication No. US-2006-0079178-A1, the patent application being incorporated herein in its entirety, by reference.

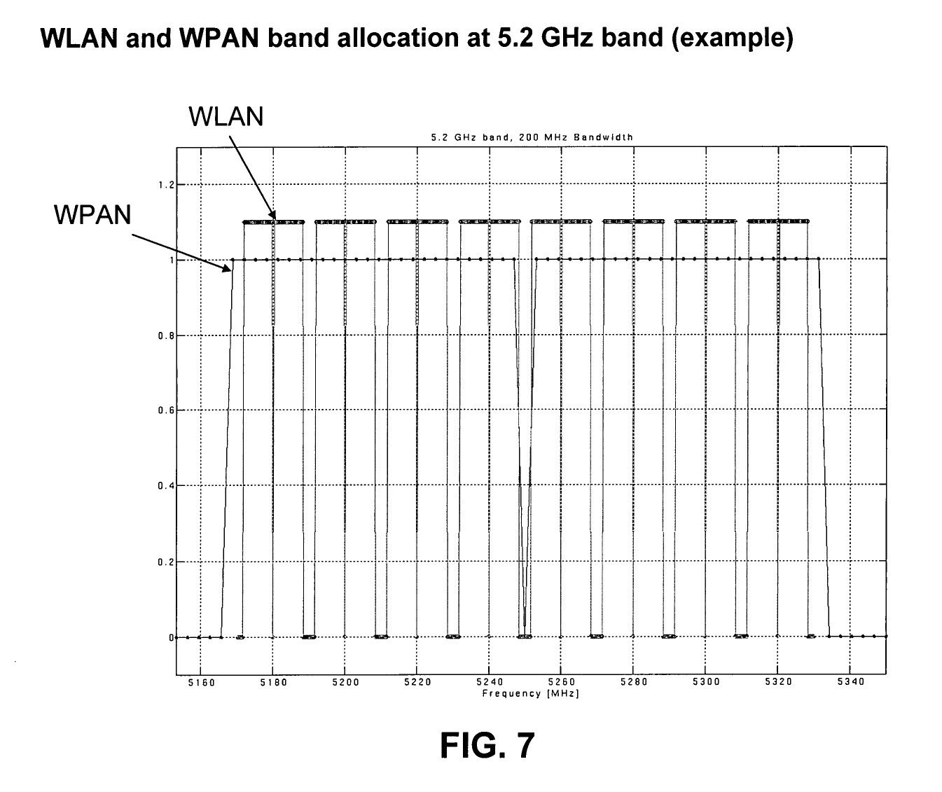

FIG. 7 is a radio frequency spectrum diagram illustrating an example of WLAN and WPAN band allocation at 5.2 GHz band, according to an aspect of the invention. The WLAN operation is performed in 20 MHz channels, while when the WLAN radio is operating in WPAN mode the bandwidth can be e.g. 100 MHz or 200 MHz. Both the WLAN and WPAN share the same frequency spectrum.

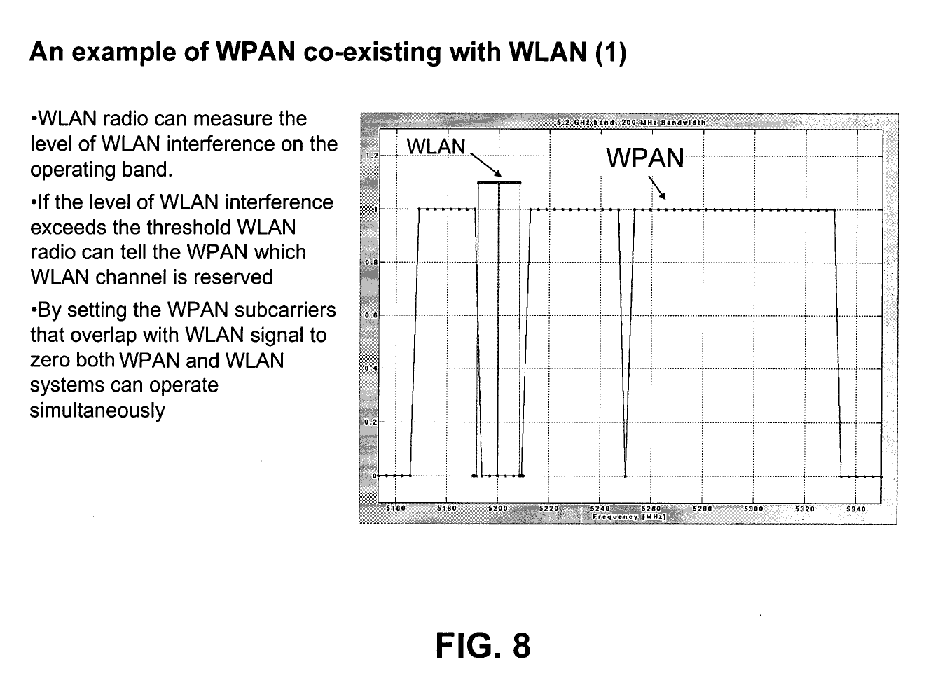

FIG. 8 is a radio frequency spectrum diagram illustrating a first example of WPAN co-existing with WLAN, wherein the WLAN radio measures the WLAN interference and based on that channel information the radio operating in WPAN mode omits using the OFDM subcarriers overlapping with the WLAN spectrum for transmission. The co-existence mechanism is based on using the channel information the WLAN radio receives for determining if there is a WLAN link operating.

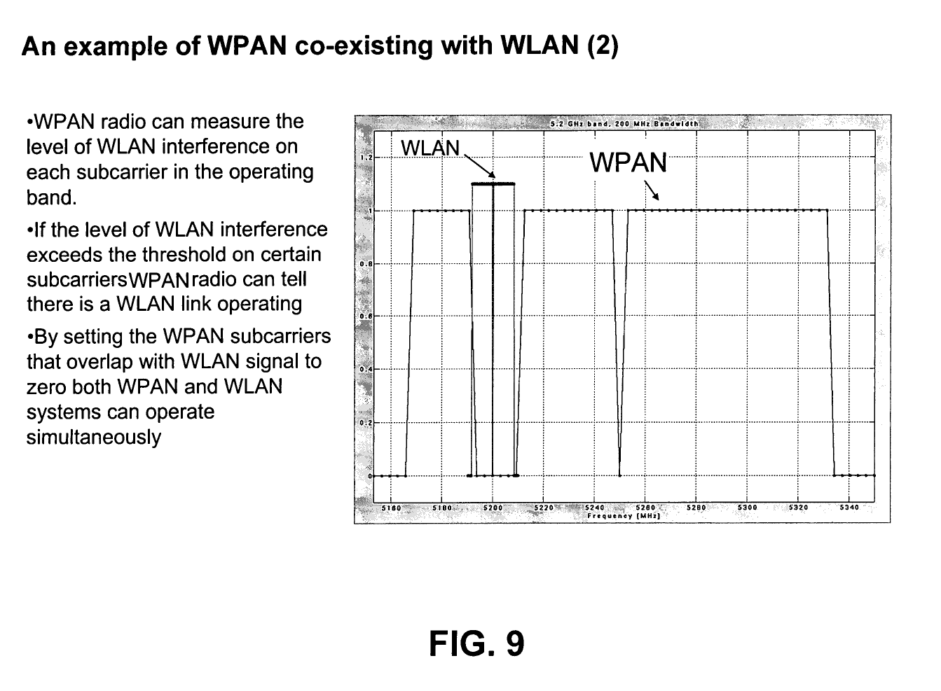

FIG. 9 is a radio frequency spectrum diagram illustrating a second example of WPAN co-existing with WLAN, wherein the WPAN radio measures the WLAN interference and based on that channel information the radio operating in WPAN mode omits using the OFDM subcarriers overlapping with the WLAN spectrum for transmission. Another alternative is to use the WPAN radio for this purpose. Based on the channel information the WPAN can avoid using the same part of spectrum as WLAN and hence co-exist with WLAN without interfering or suffering from interference.

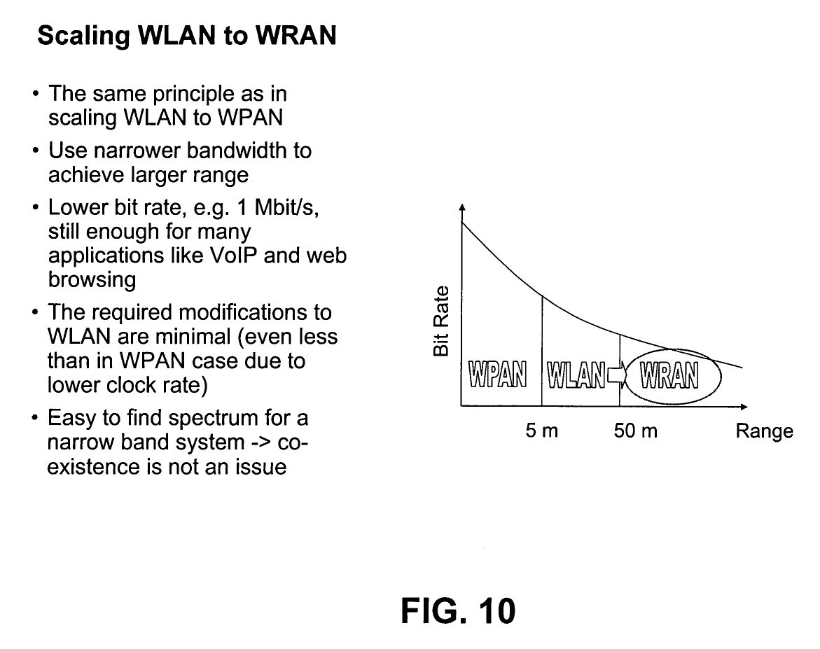

FIG. 10 is a bit rate vs. range diagram for Scaling WLAN to WRAN, illustrating that the same principle used in scaling WLAN to WPAN operation, can also be at the lower bit rate of WRAN, in which case a larger range is achieved using a narrower bandwidth and lower a clock rate. Instead of a high bit rate WPAN operation, this mode can also be applied to a lower bit rate WRAN, in which case a larger range (up to a some kilometers) is achieved using a narrower bandwidth and a lower clock rate.

While various embodiments of the present invention have been described above, it should be understood that they have been presented by way of example only, and not in limitation. For instance, although examples have been described involving Bluetooth, IEEE 802.11, UWB, and IEEE 802.15.3a technologies, other short-range and longer range, and regional area network communications technologies are within the scope of the present invention.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An apparatus for selective wireless communications, comprising:
a MAC layer logic configured to specify a MAC frame to selectively define first characteristics of a first operational mode corresponding to a first wireless link type and second characteristics of a second operational mode corresponding to a second wireless link type; and
a transceiver coupled to said MAC layer logic for transceiving in response to said MAC frame specification, a first protocol data unit for said first operational mode having said first characteristics for said first wireless link type and a second protocol data unit for said second operational mode having said second characteristics for said second wireless link type.

2. The apparatus of claim 1, which further comprises:
interference detection logic coupled to said transceiver to detect interference conditions, in said a first wireless link type and to allocate suitable areas for operation of the second wireless link.

3. The apparatus of claim 1, wherein the first wireless link type is a wireless local area network (WLAN) link and the second wireless link type is a wireless personal area network (WPAN) link.

4. The apparatus of claim 1, wherein the first wireless link type is a wireless local area network (WLAN) link and the second wireless link type is a wireless personal area network (WRAN) link.

5. The apparatus of claim 1, wherein the transceiver includes a transmitter portion configured to receive one or more operational parameters from the MAC layer logic.

6. The apparatus of claim 5, wherein the transmitter portion includes a low pass filter having a bandwidth that is determined by one of the one or more operational parameters.

7. The apparatus of claim 5, wherein the transmitter portion includes a digital to analog converter (DAC) having a sampling rate that is determined by one of the one or more operational parameters.

8. The apparatus of claim 5, wherein the transmitter portion includes a digital to analog converter (DAC) having a resolution that is determined by one of the one or more operational parameters.

9. The apparatus of claim 5, wherein the transmitter portion includes a power amplifier, that is selectively bypassed based on one of the one or more operational parameters.

10. The apparatus of claim 5, wherein the transmitter portion includes a power amplifier having a gain that is determined by one of the one or more operational parameters.

11. The apparatus of claim 1, wherein the transceiver includes a receiver portion configured to receive one or more operational parameters from the MAC layer logic.

12. The apparatus of claim 11, wherein the receiver portion includes a low pass filter having a bandwidth that is determined by one of the one or more operational parameters.

13. The apparatus of claim 11, wherein the receiver portion includes an analog to digital converter (ADC) having a sampling rate that is determined by one of the one or more operational parameters.

14. The apparatus of claim 11, wherein the receiver portion includes an analog to digital converter (ADC) having a resolution that is determined by one of the one or more operational parameters.

15. The apparatus of claim 1, wherein the first wireless link type has a data rate that is smaller than a data rate of the second wireless link type.

16. The apparatus of claim 1, wherein the first wireless link type has a bandwidth that is smaller than a bandwidth of the second wireless link type.

17. The apparatus of claim 1, wherein the MAC layer logic sets the operational mode of the transceiver according to an event.

18. The apparatus of claim 1, wherein the event includes receipt of a message indicating a particular configuration of the transceiver.

19. The apparatus of claim 1, wherein the MAC layer logic sets the operational mode of the transceiver according to an application.

20. The apparatus of claim 1, which further comprises:
interference detection logic coupled to said transceiver to detect interference conditions, in said a first wireless link type and to allocate suitable areas for operation of the second wireless link;
wherein the first wireless link type is a wireless local area network (WLAN) link and the second wireless link type is a wireless personal area network (WPAN) link.

21. A method for selective wireless communications, comprising:
specifying a MAC frame to selectively define first characteristics of a first operational mode corresponding to a first wireless link type and second characteristics of a second operational mode corresponding to a second wireless link type; and
transceiving in response to said MAC frame specification, a first protocol data unit for said first operational mode having said first characteristics for said first wireless link type and a second protocol data unit for said second operational mode having said second characteristics for said second wireless link type.

22. The method of claim 21, which further comprises:
detecting interference conditions in said a first wireless link type and to allocate suitable areas for operation of the second wireless link.

23. The method of claim 21, wherein the first wireless link type is a wireless local area network (WLAN) link and the second wireless link type is a wireless personal area network (WPAN) link.

24. The method of claim 21, wherein the first wireless link type is a wireless local area network (WLAN) link and the second wireless link type is a wireless personal area network (WRAN) link.

25. A terminal device for selective wireless communications, comprising:
a MAC layer logic configured to specify a MAC frame to selectively define first characteristics of a first operational mode corresponding to a first wireless link type and second characteristics of a second operational mode corresponding to a second wireless link type;
a transceiver coupled to said MAC layer logic for transceiving in response to said MAC frame specification, a first protocol data unit for said first operational mode having said first characteristics for said first wireless link type and a second protocol data unit for said second operational mode having said second characteristics for said second wireless link type; and
interference detection logic coupled to said transceiver to detect interference conditions, in said a first wireless link type and to allocate suitable areas for operation of the second wireless link.

26. A radio module for selective wireless communications, comprising:
a MAC layer logic configured to specify a MAC frame to selectively define first characteristics of a first operational mode corresponding to a first wireless link type and second characteristics of a second operational mode corresponding to a second wireless link type;
a transceiver coupled to said MAC layer logic for transceiving in response to said MAC frame specification, a first protocol data unit for said first operational mode having said first characteristics for said first wireless link type and a second protocol data unit for said second operational mode having said second characteristics for said second wireless link type; and
interference detection logic coupled to said transceiver to detect interference conditions, in said a first wireless link type and to allocate suitable areas for operation of the second wireless link.

27. A computer program product for selective wireless communications, comprising:
a computer readable medium;
program code in said computer readable medium, for specifying a MAC frame to selectively define first characteristics of a first operational mode corresponding to a first wireless link type and second characteristics of a second operational mode corresponding to a second wireless link type; and
program code in said computer readable medium, for transceiving in response to said MAC frame specification, a first protocol data unit for said first operational mode having said first characteristics for said first wireless link type and a second protocol data unit for said second operational mode having said second characteristics for said second wireless link type.

28. The computer program product of claim 27, which further comprises:
program code in said computer readable medium, for detecting interference conditions in said a first wireless link type and to allocate suitable areas for operation of the second wireless link.
